(19) United States
(12) Patent Application Publication
(10) Pub. No.: US 2005/0050144 A1
(43) Pub. Date: Mar. 3, 2005

(54) SYSTEM AND METHOD FOR AUTOMATED COMMUNICATION BETWEEN WEBSITES AND WIRELESS COMMUNICATIONS DEVICES

(76) Inventor: Marat Borin, San Antonio, TX (US)

Correspondence Address: JEFFREY FURR, 253 N. MAIN STREET, JOHNSTOWN, OH, 43031, US

(21) Appl. No.: 10/605,013

(22) Filed: Sep. 1, 2003

(51) Int. Cl. G06F 15/16; H04Q 7/20

(52) U.S. Cl. 709/206; 455/466

(57) ABSTRACT

This is a system and mechanism that will allow websites to automatically communicate with their visitors and members by utilizing various web-based messaging gateways to send text messages (SMS). Websites enabled with this system will be able to send a text message to the members' wireless device communicating to them various information such as advertising messages, news, and other related information.

### BACKGROUND OF INVENTION

### FIELD OF THE INVENTION

The present invention relates to Internet and, more particularly, to Short Message Service (SMS) via the Internet to wireless devices such as a cellular phone, pager, or a PDA.

### BACKGROUND

Currently websites that are membership based and that maintain a member database only communicate with their members via e-mail.

The Short Message Service (SMS) is the ability to send text messages to and receive text messages from mobile telephones. The text can be comprised of words or numbers or an alphanumeric combination. SMS was created as part of the GSM Phase 1 standard. The first short message is believed to have been sent in December 1992 form a Personal Computer (PC) to a mobile phone on the Vodafone GSM network in the United Kingdom. Each short message is up to 160 characters in length when Latin alphabets are used and 70 characters in length when non-Latin alphabets such as Arabic and Chinese, are used.

There is no doubt in the success of the Short Message Service with the market in Europe alone having reached over three billion short messages per month.

Short Message Services are provided by operators of wireless communication systems today who have digital service available. Short Message Services, or more simply put “SMS,” are messages delivered by the wireless network to a digital phone. There are three major digital standards commonly deployed throughout the US today: Code Division Multiple Access (“CDMA”), Time Division Multiple Access (“TDMA”), and Global Systems for Mobile (“GSM”).

Global Systems for Mobile (“GSM”) is a specification that was written to provide a unified digital platform that all 12 countries of the European Community (“EC”) could use from one country to the next with the same phone. Other countries outside of the EC have adopted GSM as their preferred system specification therefore increasing the volume of systems worldwide. The first systems went commercial in 1993 in Europe, while the first commercial GSM system in the United States went commercial at the end of 1995.

GSM is similar to IS-54 TDMA (see below) in that it uses FDMA to separate RF carriers and TDMA to serve up to 8 users per channel. It was developed to provide a single European standard and to facilitate many new enhanced services and automatic roaming. Initially, GSM used the 900 MHz band but has now added two compatible standards: DCS1800 at 1.8 GHz and PCS1900 at 1.9 GHz. TDMA (or D-AMPS) began life as a digital upgrade to the 800 MHz AMPS network and is commonly referred to as IS-54. It employs the 30 kHz AMPS channel split into three timeslots with a separate control channel. The standard was upgraded to IS-136 to include an integrated digital control channel and interband operability to 1900 MHz. CDMA was developed to provide further capacity enhancements over the TDMA standards. It uses Direct Sequence Code Division Multiple Access to differentiate users on the same 1.28 MHz frequency band. CDMA systems are currently operating at 800 MHz and 1900 MHz.

The United States and other countries also decided that there was enough demand for wireless services in the marketplace to introduce more competitors into each market. The amount of new competitors has varied from country to country, but they have consistently used the higher frequency band in the 1900 MHz band. This new license area is generally known as Personal Communication Services (“PCS”), and six new licensed providers have been introduced in each market throughout the US. The two existing operators are generally referred to as “Cellular” operators and operate in the 800 MHz band throughout the US.

U.S. Pat. No. 5,878,351 discloses a method and apparatus for providing delayed transmission of SMS delivery acknowledgment, manual acknowledgment, and SMS messages; it allows for the buffering of transmissions and the ability to send those buffered messages at a later date. It does not, however, have those buffered transmissions being sent at a user defined date.

Japanese Patent 10004432A2 discloses an Electronic mail service gateway, a short message processor communication system, and an electronic mail transmission method to mobile terminal equipment. It is a mobile communication network (GSMN) that is provided with a short message service center SMSC. Then a gateway MSG is provided with a decomposing means that decomposes an electronic mail message so as to generate a sequence of a data block led by a mobile communication network and an insert means that inserts continuous data blocks of a succeeding short message, uses the short message services and supplies the short message to a short message port SMP of a mobile communication network led to mobile terminal equipment.

U.S. Pat. No. 5,678,179 by Turcotte, et al. discloses a Message transmission system and method for a radiocommunication system. It is a method and system for message signaling in a radiocommunication system.

U.S. Pat. No. 6,134,432 by Holmes, et al. discloses a system and process for allowing wireless messaging. It discloses a bi-directional (and/or uni-directional) multiplexing messaging gateway for wireless devices, such as for devices using the Global System for Mobile Communication (GSM) wireless digital standard, or any other suitable protocols.

U.S. Pat. No. 6,061,718 by Nelson discloses an Electronic mail delivery system in wired or wireless communications system. It is an electronic mail (E-mail) delivery system for delivering E-mail messages to and from a subscriber station in a wireless or wired communications system. The E-mail delivery system converts E-mail messages sent to the subscriber station from text to speech for delivery to the subscriber station. Furthermore, the E-mail delivery system converts E-mail messages sent by the subscriber station from speech to text for delivery to a remote destination.

There is still room for improvement within the art.

### SUMMARY OF INVENTION

In accordance with the present invention, there is provided a system that will allow websites to automatically, and without the website operators involvement, communicate with their visitors and members by utilizing various web-based messaging gateways. Websites enabled with this system will be able to send a text message to the members' wireless device communicating to them various information such as advertising messages, news, and other related information.

It is an object of this invention to provide an improved and efficient method of communicating between a website and its members.

Examples of Uses:

1) This system can be used on a classified ads website in which a member of this site, wishing to be notified of an item that has been listed for sale, can receive a text message to his cellular phone notifying him that such item has been listed on the website.

2) This system can also be used on an auction website such as eBay® to notify a participating bidder if he or she has been outbid.

3) A member of a dating/matchmaking website can be notified if there is a match. Websites database is scanned for potential matches and the website using this system sends a text message to both members with a message that they have a match.

### BRIEF DESCRIPTION OF DRAWINGS

A complete understanding of the present invention may be obtained by reference to the accompanying drawings, when considered in conjunction with the subsequent, detailed description, in which:

FIG. 1 is a block diagram of a mobile station that is constructed and operated in accordance with this invention;

FIG. 2 is an lavational view of the mobile station shown in FIG. 1, and which further illustrates a cellular communication system to which the mobile station is bidirectionally coupled through wireless RF links;

FIG. 3 shows a functional diagram of a computer network for accessing the calendar system through the Internet;

FIG. 4 shows the Basic operation; and

FIG. 5 is a logic flow diagram that illustrates how the system transmits an SMS event messages to the destination address.

For purposes of clarity and brevity, like elements and components will bear the same designations and numbering throughout the FIGURES.

### DETAILED DESCRIPTION

The present invention is a system 1 that will allow websites to automatically, and without the website operators involvement, communicate with their visitors and members by utilizing various web-based messaging gateways. Websites enabled with this system will be able to send a text message to the members' wireless device communicating to them various information such as advertising messages, news, and other related information.

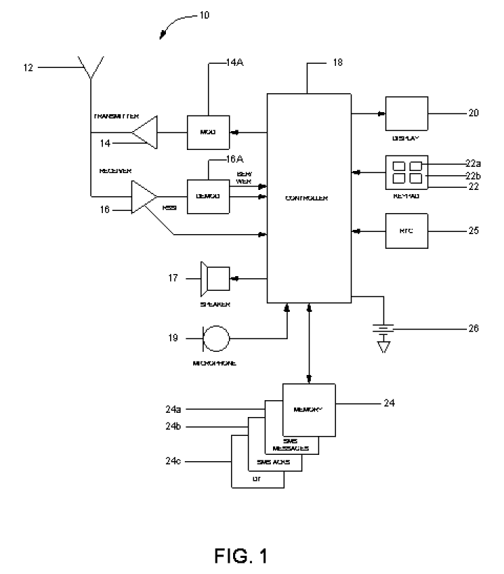

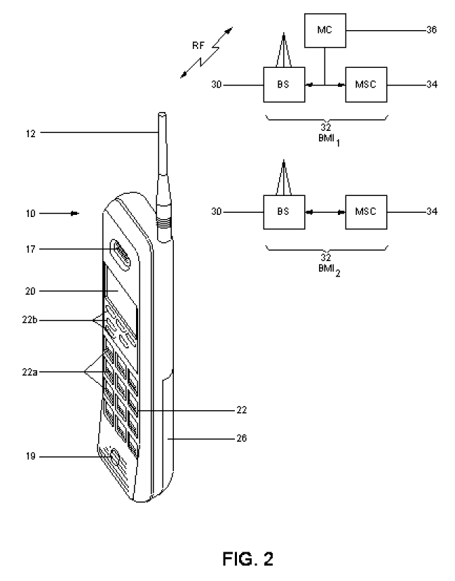

Reference is made to FIGS. 1 and 2 for illustrating a wireless user terminal or mobile station 10, such as, but not limited to, a cellular radiotelephone or a personal communicator that is suitable for practicing this invention. The mobile station 10 includes an antenna 12 for transmitting signals to and receiving signals from a first base site or base station 30. The base station 30 is a part of a first cellular network comprising a Base Station/Mobile Switching Center/Interworking function (BMI.sub.1) 32 that includes a mobile switching center (MSC) 34 and a Message Center (MC) 36. The MSC 34 provides a connection to landline trunks when the mobile station 10 is involved in a call. FIG. 2 also shows a second BMI.sub.2 32′, having associated base station(s) 30′ and MSC 32′. The second BMI 32′ may or may not include a message center.

The mobile station includes a modulator (MOD) 14A, a transmitter 14, a receiver 16, a demodulator (DEMOD) 16A, and a controller 18 that provide signals to and receives signals from the transmitter 14 and receiver 16, respectively. These signals include signaling information in accordance with the air interface standard of the applicable cellular system, and also user speech and/or user generated data. The air interface standard is assumed for this invention to include a physical and logical frame structure of a type that was described above, although the teaching of this invention is not intended to be limited only to this specific structure, or for use only with an IS-136 compatible mobile station, or for use only in TDMA type systems.

It is understood that the controller 18 also includes the circuitry required for implementing the audio and logic functions of the mobile station. By example, the controller 18 may be comprised of a digital signal processor device, a microprocessor device, and various analog to digital converters, digital to analog converters, and other support circuits. The control and signal processing functions of the mobile station are allocated between these devices according to their respective capabilities.

A user interface includes a conventional earphone or speaker 17, a conventional microphone 19, a display 20, and a user input device, typically a keypad 22, all of which are coupled to the controller 18. The keypad 22 includes the conventional numeric (0-9) and related keys (#,*) 22a, and other keys 22b used for operating the mobile station 10. These other keys 22b may include, by example, a SEND key, various menu scrolling and soft keys, and a PWR key. The mobile station 10 also includes a battery 26 for powering the various circuits that are required to operate the mobile station.

The mobile station 10 also includes various memories, shown collectively as the memory 24, wherein are stored a plurality of constants and variables that are used by the controller 18 during the operation of the mobile station. For example, the memory 24 stores the values of various cellular system parameters and the number assignment module (NAM). An operating program for controlling the operation of controller 18 is also stored in the memory 24 (typically in a ROM device). The memory 24 may also store data, including point-to-point and Broadcast SMS messages 24a, which are received from the BMI 32 prior to the display of the messages to the user. In accordance with an aspect of this invention, the memory 24 also stores, when required, any SMS acknowledgement (ACK) messages 24b, such as Delivery ACK and Manual ACK, that cannot be sent when required. Typically, the Delivery ACK message is intended to be transmitted when a corresponding SMS message, which specifies Delivery ACK, is displayed to the user. The Manual ACK is intended to be transmitted in response to an input from the user after reading the corresponding SMS message. Preferably the SMS messages 24a and the buffered acknowledgements 24b are stored in a non-volatile portion of the memory 24 so that this information is not lost should power be removed.

In greater detail, and referring to an IS-136 embodiment, the SMS Manual ACK message is defined to be sent from a mobile station as a result of the user responding to a previously received SMS Deliver message. The mobile station 10 sets a Message Reference in the SMS Manual ACK to the Message Reference in the SMS Deliver message that is being user acknowledged. In addition, the mobile station 10 sets the User Destination Address and User Destination Subaddress in the R-DATA message (see, for example, Section 6.4.3.11) in which the SMS Manual ACK is sent to the User Originating Address (if included) and User Originating Subaddress (if included) in the R-DATA message in which the SMS Deliver message being acknowledged was received.

Reference can be had to commonly assigned and allowed U.S. Pat. No. 5,604,921 issued Feb. 18, 1997., entitled “Radiotelephone User Interface for Broadcast Short Message Service” by Seppo Alanara.

It should be understood that the mobile station 10 can be a vehicle mounted or a handheld device. It should further be appreciated that the mobile station 10 can be capable of operating with one or more air interface standards, modulation types, and access types. By example, the mobile station may be capable of operating with any of a number of other standards besides IS-136, such as GSM and IS-95 (CDMA). Some narrow-band AMPS (NAMPS), as well as TACS, mobile stations may also benefit from the teaching of this invention, as should dual or higher mode phones (e.g., digital/analog or TDMA/CDMA/analog phones). It should thus be clear that the teaching of this invention is not to be construed to be limited to any one particular type of mobile station or air interface standard.

The operating program in the memory 24 includes routines to present messages and message-related functions to the user on the display 20, typically as various menu items. The memory 24 also includes routines for implementing the methods.

In a first aspect, a presently preferred embodiment of this invention employs point-to-point or point-to-multipoint teleservices that build upon the R-DATA message (see Sections 2.7.3.1.3.2.19 and 3.7.3.1.3.2.23 of IS-136.2, and Sections 6.4.3.11 and 6.4.4.9 of IS-136.1). Each teleservice is identified by a unique value of the higher layer protocol identifier field within the R-DATA unit information element that is included within the R-DATA message. Of most interest herein is the Cellular Messaging Teleservice (CMT), in particular a SMS function that requires either that the Delivery ACK or Manual ACK be transmitted by the mobile station 10 after message presentation to a user.

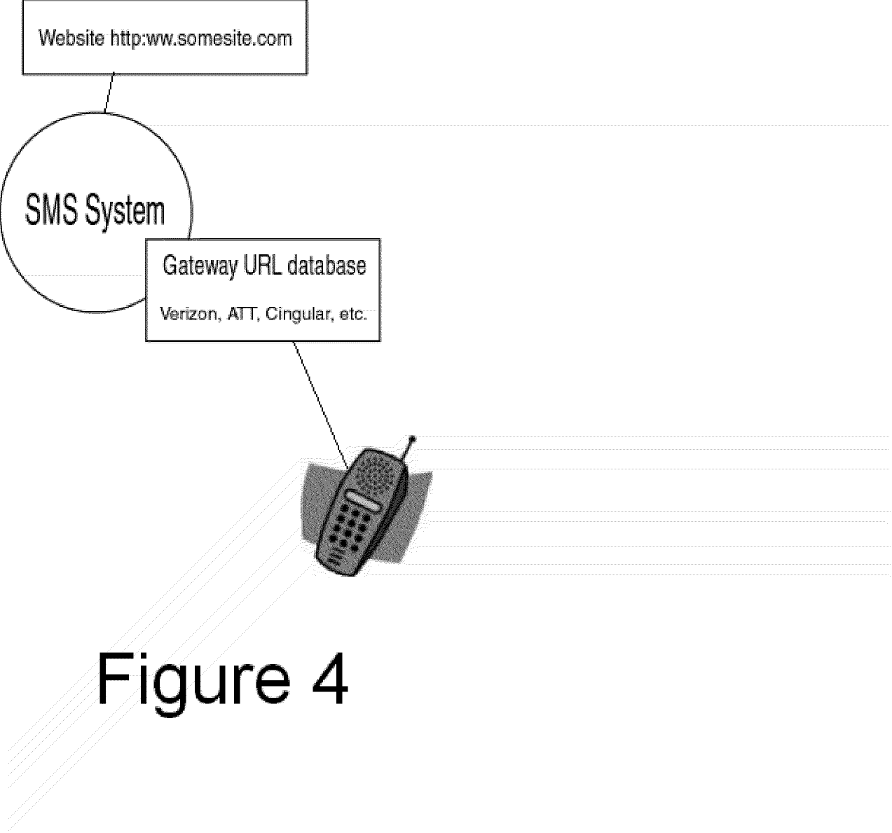

This SMS System 1, as shown in FIG. 4, is software based and can be written (coded) in various computer languages such as Perl and PHP. The software is comprised of several elements, most important of which is a database of wireless Carrier Gateway URL Database and a mechanism of utilizing this database to send text messages to wireless devices depending on the carrier that the wireless device is enabled with. The main purpose of this software system is to enable websites to communicate with members by utilizing carrier's SMS gateways (carrier owned websites). This system is simply a bridge between the website and the SMS gateway.

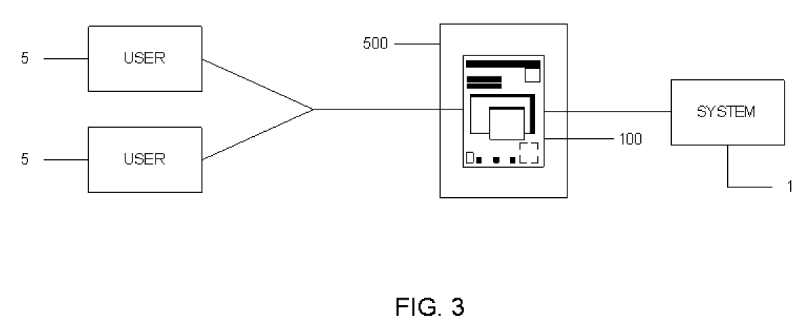

The software would be contained on a server that would be accessible to the Users 5 through the Internet. FIG. 3 illustrates a functional diagram of a computer network for World Wide Web access to the system 1 from a plurality of Users 5 to a Web site 100. Accessing a Web site 100 on the system 1 can be accomplished directly through a communication means such as a local Internet Service Provider, often referred to as ISPs, or through an on-line service provider like CompuServe, Prodigy, American On-line, etc.

The Users 5 contact a Web site 100 using an informational processing system capable of running an HTML compliant Web browser such as Microsoft's Internet Explorer, Netscape Navigator, Lynx, and Mosaic. A typical system that is used is a personal computer with an operating system, such as Windows 95, 98, ME, NT or XP or Linus, running a Web browser. The exact hardware configuration of computer used by the Users 5, the brand of operating system or the brand of Web browser configuration is unimportant to understand this present invention. Those skilled in the art can conclude that any HTML (Hyper Text Markup Language) compatible Web browser is within the true spirit of this invention and the scope of the claims.

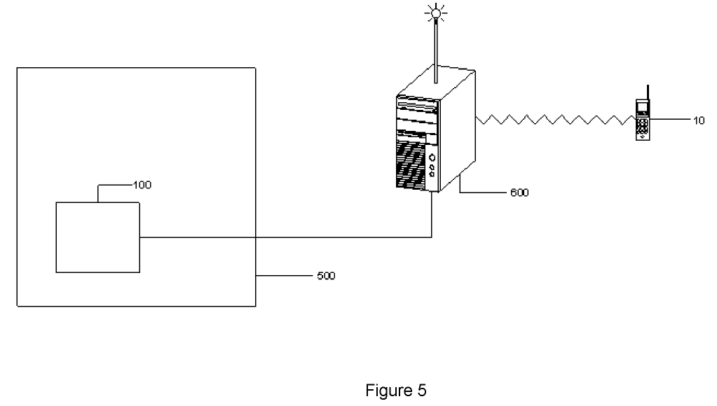

As shown in FIG. 5, the descriptions which are at this point SMS messages are going to be written by the system 1 from a central location to a Mobile Phone user. The process is as follows: Web Site Server→SMS server→Users' mobile phone.

What the system 1 has to do is send the message from the system's web site 100 to the Mobile Operator SMS server 600. Then the Mobile Operator SMS server 600 sends the message to the mobile station 10 through its preexisting system. The system 1 sends the SMS messages from the central location to the Mobile Operator SMS 600 server using the protocol that is used by Mobile Operator. For example, if the Mobile Operator is using the following format: “Mobile Phone Number, Message”The system will just use the same format to send the SMS to the SMS server.For example: “98761234, test” If the Mobile Operator's SMS server is accessible from Internet, any computer that is connected to Internet can contact that SMS 600 server as long as the access privilege is granted by Mobile Operator. The Mobile Operator' s SMS server is contacted through the Internet by a process that is similar to contacting a web site from your computer using a browser. This will be done by the system through the use of software (similar to a browser) in system to contact the Mobile Operator SMS server and send the SMS using the protocol that they are using.

The SMS event message is transmitted by the SMS server 600 to a cellular network for transmission to the destination address where it is displayed on the mobile station for viewing by the receiver.

The system 1 is for automated communication between websites and wireless communications devices for websites and website operators who wish to instantly communicate with their members and or website visitors. It has a SMS system rigidly embedded to a Website 100, a carrier gateway website database, rigidly linked to said SMS System; and a wireless device, remotely connected to said Carrier Gateway URL Database.

The system 1 can be used on a classified ads website in which a member of this site, wishing to be notified of an item that has been listed for sale, can receive a text message to his cellular phone notifying him that such item has been listed on the website.

The system 1 can also be used on an auction website such as eBay® to notify a participating bidder if he or she has been outbid.

The system 1 can be used by a member of a dating/matchmaking website can be notified if there is a match. Websites database is scanned for potential matches and the website using this system sends a text message to both members with a message that they have a match.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

1. The system and method for automated communication between websites and wireless communications devices, wherein said means for <purpose> comprises a carrier gateway website database.

2. The system and method for automated communication between websites and wireless communications devices in accordance with claim 1, wherein said means for communication comprises a wireless device.

3. A system and method for automated communication between websites and wireless communications devices for websites and website operators who wish to instantly communicate with their members and or website visitors. Comprising:
a SMS system rigidly embedded to a Website;
a carrier gateway website database, rigidly linked to said SMS System; and
a wireless device remotely connected to said Carrier Gateway URL Database.

4. A system and method in accordance to claim 3, wherein said system is used for a classified ads website.

5. A system and method in accordance to claim 3, wherein said system is used for an auction website.

6. A system and method in accordance to claim 3, wherein said system is used for a dating/matchmaking website.
